(19) United States
(12) Patent Application Publication
(10) Pub. No.: US 2004/0238617 A1
(43) Pub. Date: Dec. 2, 2004

(54) Identifying method, identifying chip and identifying system

(76) Inventor: Shigeo Miyagawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/491,367

(22) PCT Filed: Oct. 4, 2001
(86) PCT No.: PCT/JP01/08761

(51) Int. Cl. G06F 17/00

(52) U.S. Cl. 235/375

(57) ABSTRACT

An identification process according to the present invention performs identification with a swallowable identification chip 1. In this process, first, identification information for identifying a person to be identified is input to the identification chip 1. Then, the identification chip 1 where the identification information is input is provided to the person to be identified such as a passenger. The person swallows the identification chip 1 when facing a danger. For identification, the identification chip 1 is taken from the person's body. This process enables reliable identification in a short time.

### TECHNICAL FIELD

The present invention relates to an identification process for identifying victims in case of an aircraft accident, for example. The present invention also relates to an identification chip and an identification system for implementing the identification process.

### BACKGROUND ART

In spite of strict safety control, no air craft or tall building is free from accidental disasters. In the event of a disaster, it is necessary to identify victims to contact those related to the victims and so on. The identification of the victims, however, is difficult in such disasters as aircraft crash and building fire since there are a number of victims and their bodies are seriously destroyed. Though, recently, a DNA test is sometimes used for identification, it takes a long time to obtain a test result. The identification from victims' possessions is difficult since the possessions are burned down in most cases of disasters with fire. Further, though dental records are also sometimes used for identification, the dental records are not easily accessible and hence it takes much time and effort to obtain the result of investigation.

As described above, conventional identification processes require considerable effort and time.

The present invention has been accomplished to solve the above problem and an object of the present invention is thus to provide an identification process capable of reliable identification in a short time, and an identification chip and an identification system for implementing the identification process.

### DISCLOSURE OF THE INVENTION

According to the present invention, there is provided an identification process of performing identification with a swallowable identification chip, including a step of inputting identification information for identifying an individual to be identified to the identification chip, and a step of providing the identification chip where the identification information is input to the individual to be identified. This process enables reliable identification in a short time.

The identification process may further comprise a step that an individual to be identified swallows the identification chip.

In the step of providing the identification chip to an individual to be identified, it is preferred to attach the identification chip to a ticket.

The identification chip may include a spherical semiconductor on which the identification information is stored.

The identification information is preferably information indicating a biological profile of an individual to be identified. This enables absolutely identifying an individual.

According to the present invention, there is provided an identification chip to be swallowed by an individual to be identified and used for identification, including a storage unit storing identification information of the individual to be identified, an input unit for inputting the identification information to the storage unit, and an output unit for outputting the identification information from the storage unit. By swallowing this identification chip, it enables reliable identification in a short time.

The storage unit may comprise a spherical semiconductor.

The input unit and the output unit may comprise an antenna, a transmitter circuit, and a receiver circuit, and wirelessly communicate with an external unit.

Preferably, the identification chip further includes a power converter for receiving a radio wave from an external unit and converting the radio wave into electric power. This can eliminate the need for providing a power source in the identification chip to allow downsizing, and avoid the use of a battery that can be toxic.

The identification chip may further include a non-toxic cover.

The identification chip preferably further includes a switching unit for controlling on/off of an operation of an internal circuit. This enables control for operating only a chip requiring identification.

According to the present invention, there is provided an identification system for identification, including a swallowable identification chip for storing identification information, and an input unit for inputting the identification information to the identification chip. This configuration enables reliable identification in a short time.

The identification system may further include a biological information obtaining unit for obtaining information indicating a biological profile of an individual to be identified, and a unit for inputting biological information obtained by the biological information obtaining unit to the identification chip. This enables absolutely identifying an individual.

The identification system may further include a terminal connected to the input unit, a server connected to the terminal through a communication network, and a reader connected to the server through a communication network, wherein the terminal comprises a unit for transmitting identification information input to the identification chip to the server through a communication network, the server comprises a storage unit for receiving identification information from the terminal and storing the identification information, and the reader comprises a unit for reading identification information from the identification chip and transmitting the identification information to the server. This configuration facilitates identification.

### BRIEF DESCRIPTION OF THE DRAWINGS

FIG. 1 is a view to explain an identification process according to the present invention.

FIG. 2 is a view showing a configuration of an ID chip according to the present invention.

FIG. 3 is a view to explain another identification process according to the present invention.

FIG. 4 is a view showing a configuration of an identification system according to the present invention.

FIG. 5 is a view showing a configuration of an ID chip according to the present invention.

FIG. 6 is a view showing a configuration of an ID chip according to the present invention.

FIG. 7 is a view showing a configuration of a reader according to the present invention.

FIG. 8 is a flowchart showing a process flow of an identification system according to the present invention.

FIG. 9 is a flowchart showing a process flow of an identification system according to the present invention.

FIG. 10 is a flowchart showing a process flow of an identification system according to the present invention.

FIG. 11 is a flowchart showing a process flow of an identification system according to the present invention.

FIG. 12 is a view showing a configuration of an ID chip according to the present invention.

### BEST MODES FOR CARRYING OUT THE INVENTION

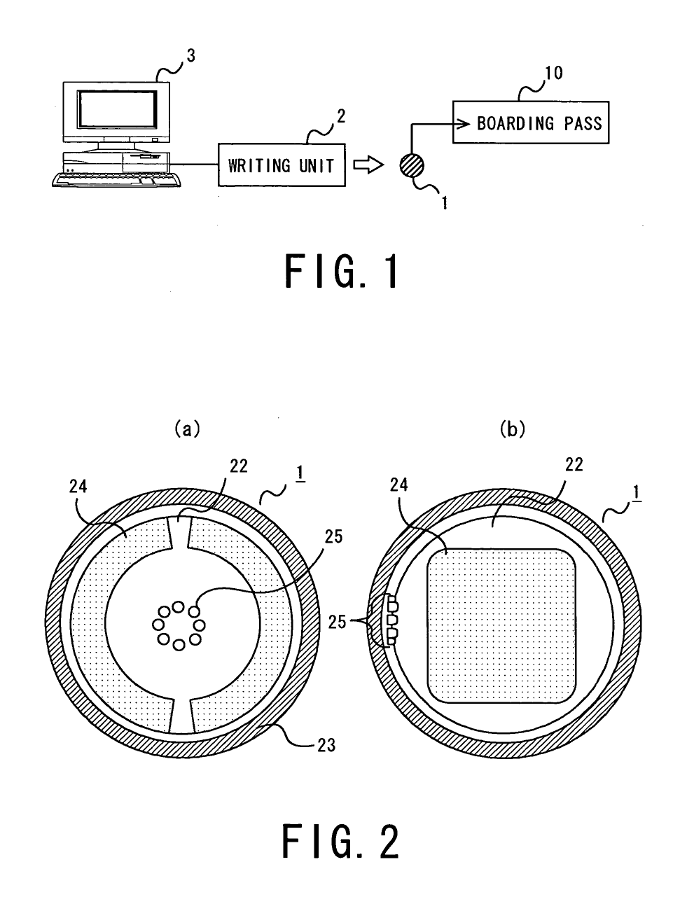

FIG. 1 is a view to explain an identification process according to the present invention. In this embodiment, an identification process for identification in case of an aircraft accident will be explained.

The implementation of the identification process uses an ID chip 1, a writing unit 2, and a terminal 3 as shown in FIG. 1. The writing unit 2 and the terminal 3 are installed at a check-in counter in an airport, for example.

The ID chip 1 is a chip for identification, and it is distributed to passengers, who are to be identified, in check-in procedures, for example. When the passenger determines to be an emergency, he/she swallows the ID chip 1. If the passenger falls victim to a disaster, he/she can be identified by analyzing the swallowed ID chip 1. For this purpose, the ID chip 1 includes a storage unit such as memory where information for identifying the passenger is at least stored. The information for identifying the passenger may be information of the passenger's name, age, gender, address, and so on, or information of a given letter/digit string assigned at boarding. Further, it may be information indicating biological profiles of the passenger such as a picture, fingerprint, DNA information, and the shape of the pupil edge. It is thereby possible to absolutely identify the passenger.

The writing unit 2 and the terminal 3 are used to store the identification information in the ID chip 1. The writing unit 2, for example, has an external terminal connected to a terminal of the ID chip 1, and inputs the information output from the terminal 3 to the terminal of the ID chip 1 through the external terminal.

Since the ID chip 1 is used by swallowing, thus intended for oral use, its size is limited by necessity to a swallowable size, such as the size of an oral tablet. Though a smaller size chip allows less difficulty in swallowing, if the chip is too small, it becomes lodged in the stomach wall or the intestinal wall and is not passed out of the body. Thus, it is preferably not less than 1 mm in diameter.

The terminal 3 is a computer such as a personal computer or a single purpose computer. It includes a control section such as CPU or MPU, a storage section such as ROM, RAM, or hard disk, an input section such as a keyboard or a mouse, an output section such as a display, and an interface circuit for connection with an external unit such as the writing unit 2. In the terminal 3 according to this embodiment, a processing program to execute the operation of writing the identification information input from the input section or an external database to the ID chip 1 through the writing unit 2 is installed in the storage section.

The ID chip 1 is handed to each passenger when ticketing, attached to a boarding pass 10, for example.

FIG. 2 shows a specific configuration of the ID chip 1. The ID chip 1 may be a normal flat rectangular semiconductor chip, but this embodiment uses a spherical semiconductor chip. FIGS. 2(a) and 2(b) are a front view and a side view, respectively, showing a basic configuration of the spherical semiconductor chip. The spherical semiconductor chip, for example, has a semiconductor 11 composed of spherical silicon (Si) and so on with approximately 1 mm in diameter, on which an electronic circuit 13 with a given processing capability composed of a plurality of transistors, resistive elements, and so on is formed. The electronic circuit 13 includes memory for storing identification information. A plurality of pads 14 for connecting the electronic circuit 13 to an external unit is also formed on the semiconductor 11. The external unit is the writing unit 2 and a reading unit (not shown) in this embodiment. The plurality of pads 14 are arranged in a ring shape at regular intervals on a given circumference with a certain diameter, for example. The number of the pads 14 is eight, for example, including a positive and negative pair of connection pads for power connection, though the number depends on the specifications (the number of data input/output lines) of the electronic circuit 13. The semiconductor 11 is entirely covered with a cover 12. The cover 12 serves as a protection of the semiconductor 11 from heat under the situation that a body is destroyed by fire, from static damage, and from moisture, and so on. The cover 12 is formed of synthetic resin or metal, for example. The cover 12 is preferably not toxic. Though the ID chip 1 is swallowed in the event of an emergency, disaster may be avoided, and it causes harm to a human body if the cover 12 is toxic. Further, the cover 12 preferably has no sharp portion in order not to damage the throat, stomach wall, or intestinal wall.

Embodiment 2

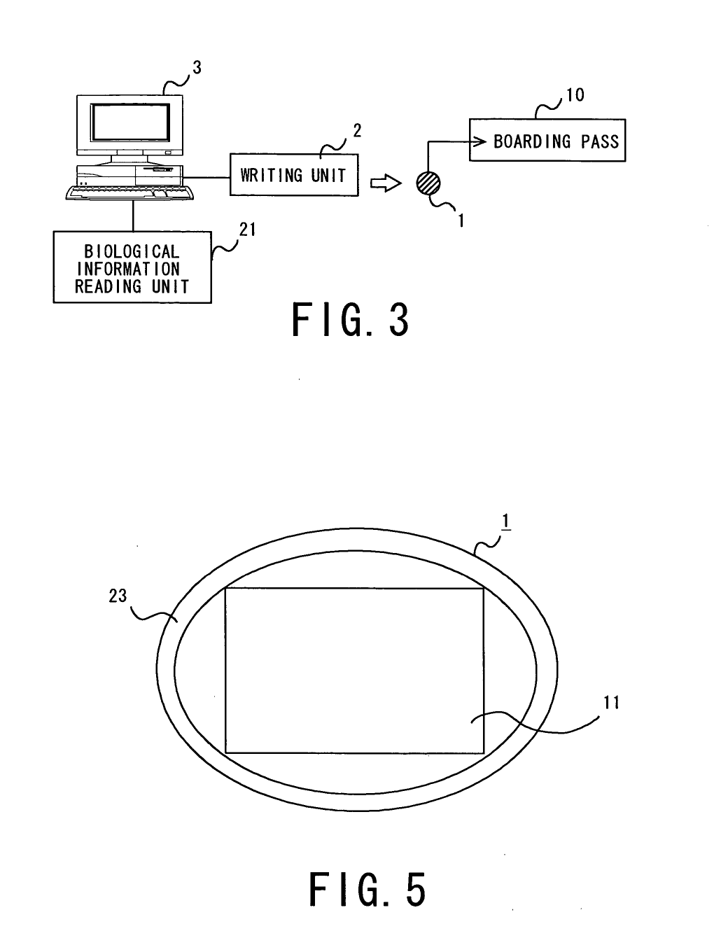

As shown in FIG. 3, a biological information reading unit 21 may be connected to the terminal 3. The biological information reading unit 21 reads biological profiles of passengers such as a picture, fingerprint, DNA information, and the shape of the pupil edge. The configuration of the biological information reading unit 21 varies according to biological information to be read. For example, the biological information reading unit 21 is a digital camera if the biological information is a picture, and it is a fingerprint identification unit if the information is a fingerprint.

In this embodiment, the terminal 3 reads the biological information of a passenger by the biological information reading unit 21 and writes the biological information to the ID chip 1 by the writing unit 2. The information for identifying individuals is thereby effectively written to the ID chip 1.

Embodiment 3

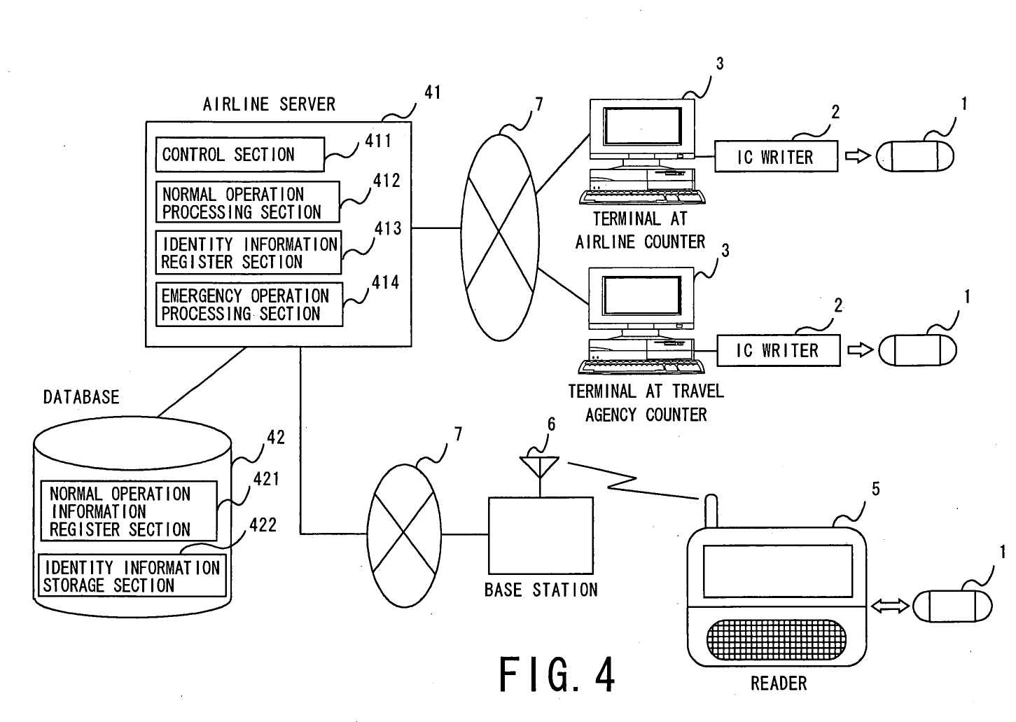

FIG. 4 is a block diagram showing an identification system according to the third embodiment of the present invention. This system has, besides the ID chip 1, an IC writer 2 as the writing unit, and the terminal 3, a server 41 of an airline, database 42, and a reader 5. The terminal 3 is connected to communicate with the airline server 41 through a communication network 7 such as a dedicated line or internet. In this case, the terminal 3 is installed in an airline counter and in a travel agency counter.

The reader 5 is connected to communicate with the server 41 through a base station 6 on a mobile communication network and a communication network 7. The reader 5 at least can read identification information from the ID chip 1. The reader 5 is preferably portable to enable the identification work at an aircraft crash site such as a forest land.

The server 41 is composed, for example, of a single purpose computer, personal computer, or a server unit. It includes a control section 411, a normal operation processing section 412, an identity information register section 413, and an emergency operation processing section 414. The control section 411, which is a processor such as CPU or MPU, executes a processing program stored in a storage unit to enable the processing of the normal operation processing section 412, the identity information register section 413, and the emergency operation processing section 414.

The normal operation processing section 412 executes the processing of normal operations such as reservation and flight management. The identity information register section 413 is a processing unit specific to the identification system according to this embodiment. It executes the processing for storing and registering the identity information of passengers in the database, which will be described next. The emergency operation processing section 414 executes the processing under emergency situations such as airplane crash.

The database 42 includes a normal operation information storage section 421 and an identity information storage section 422. The normal operation information storage section 421 stores information required for normal operations. The identity information storage section 422 stores the identity information registered by the identity information register section 413.

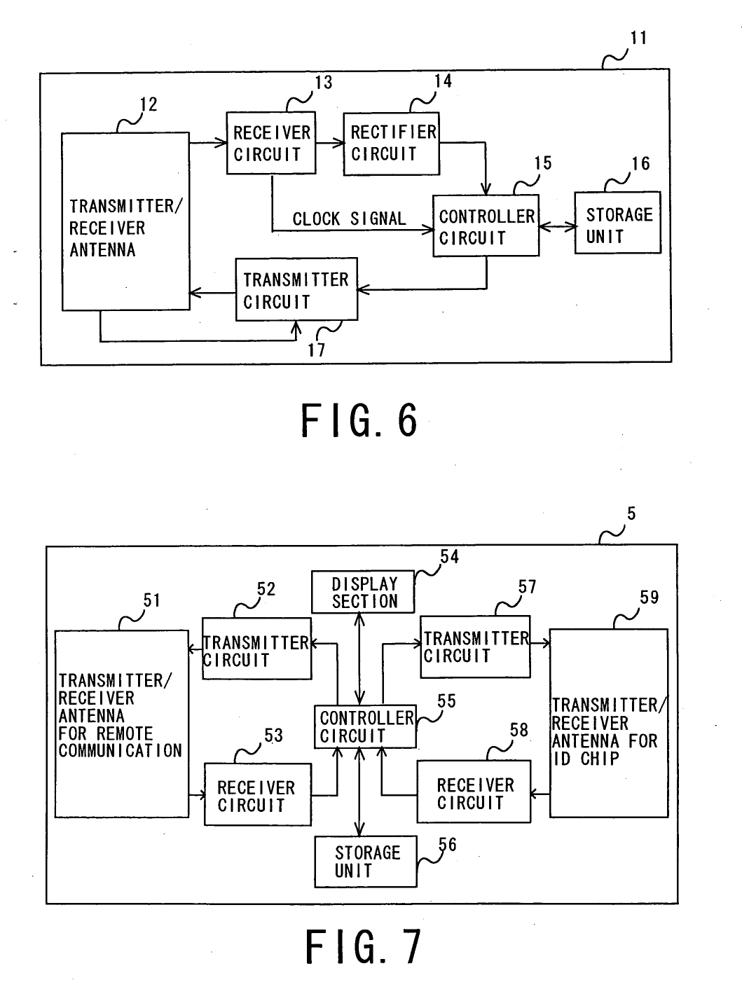

FIG. 5 and FIG. 6 show an example of the configuration of the ID chip 1 used in the system according to this embodiment. As shown in FIG. 5, the ID chip 1 is composed of a chip body 11 and a cover 12. The chip body 11 includes a transmitter/receiver antenna 12, a receiver circuit 13, a rectifier circuit 14, a controller circuit 15, a storage unit 16, and a transmitter circuit 17 as shown in FIG. 6.

The transmitter/receiver antenna 12 receives a request wave from the reader 5 or the IC writer 2 and transmits a response wave. The receiver circuit 13 generates a clock signal CLK from the request wave received by the transmitter/receiver antenna 12. The rectifier circuit 14 converts the request wave into electric power. The controller circuit 15 outputs identification information from the storage unit 16 when the clock signal CLK is input. The storage unit 16 stores identification information. The transmitter circuit 17 multiplexes the request wave received by the transmitter/receiver antenna 12 with identification information.

FIG. 7 shows an example of the configuration of the reader 5 used in the system according to this embodiment. As shown in FIG. 7, the reader 5 includes a transmitter/receiver antenna 51 for remote communication, a transmitter circuit 52, a receiver circuit 53, a display section 54, a controller circuit 55, a storage unit 56, a transmitter circuit 57, a receiver circuit 58, and a transmitter/receiver antenna 59 for ID chip.

The transmitter/receiver antenna 51 for remote communication communicates with the base station 6. The transmitter circuit 52 transmits information to the base station 6 through the transmitter/receiver antenna 51 for remote communication. The receiver circuit 53 receives information from the base station 6 through the transmitter/receiver antenna 51 for remote communication. The display section 54, which is composed of a liquid crystal display and its display circuit, for example, displays information such as identification information. The controller circuit 55 controls the components of the reader 5 such as the transmitter circuits 52 and 57, the receiver circuits 53 and 58, and the display section 54. The storage unit 56 temporarily stores identification information and so on that has been read. The transmitter circuit 57 generates a carrier wave. The transmitter/receiver antenna 59 for ID chip transmits the carrier wave as a request wave and receives a response wave. The receiver circuit 58 extracts identification information from the response wave received by the transmitter/receiver antenna 59 for ID chip.

The processing between the ID chip 1 and the reader 5 will be explained hereinbelow. The transmitter circuit 57 of the reader 5 outputs a carrier wave to the transmitter/receiver antenna 59 for ID chip. The transmitter/receiver antenna 59 for ID chip sends it out as a request wave having a frequency of f1.

The ID chip 1 receives the request wave by the transmitter/receiver antenna 12 and the receiver circuit 13. Then, the rectifier circuit 14 converts the request wave received by the transmitter/receiver antenna 12 and the receiver circuit 13 into electric power. The electric power is supplied to the controller circuit 15, which thereby starts operating. In the meanwhile, the receiver circuit 13 generates a clock signal CLK from the request wave received by the transmitter/receiver antenna 12.

Upon receiving the clock signal CLK from the receiver circuit 13, the controller circuit 15 reads identification information from the storage unit 16. Then, the transmitter circuit 17 converts the request wave received by the transmitter/receiver antenna 12 into a carrier wave,_multiplexes it with the identification information, and transmits it to the transmitter/receiver antenna 12. As a result of FSK modulation of the carrier wave with the identification information in the transmitter circuit 17, the frequency becomes f1+f2. Thus, a response wave having a frequency of f1±f2 is sent out from the transmitter/receiver antenna 12. Then, the receiver circuit 58 of the reader 5 extracts the identification information from the response wave received by the transmitter/receiver antenna 59 for ID chip. The identification information from the ID chip 1 is thereby read. The request wave transmitted from the reader 5 serves as a carrier wave of identification information transmitted from the ID chip 1 to the reader 5 and also as a power supply wave for supplying electric power to drive the controller circuit 15. Hence, no battery is required for the ID chip 1. Since a battery generally contains toxic substances, the configuration requiring no battery is favorable for the ID chip 1, which is used by swallowing.

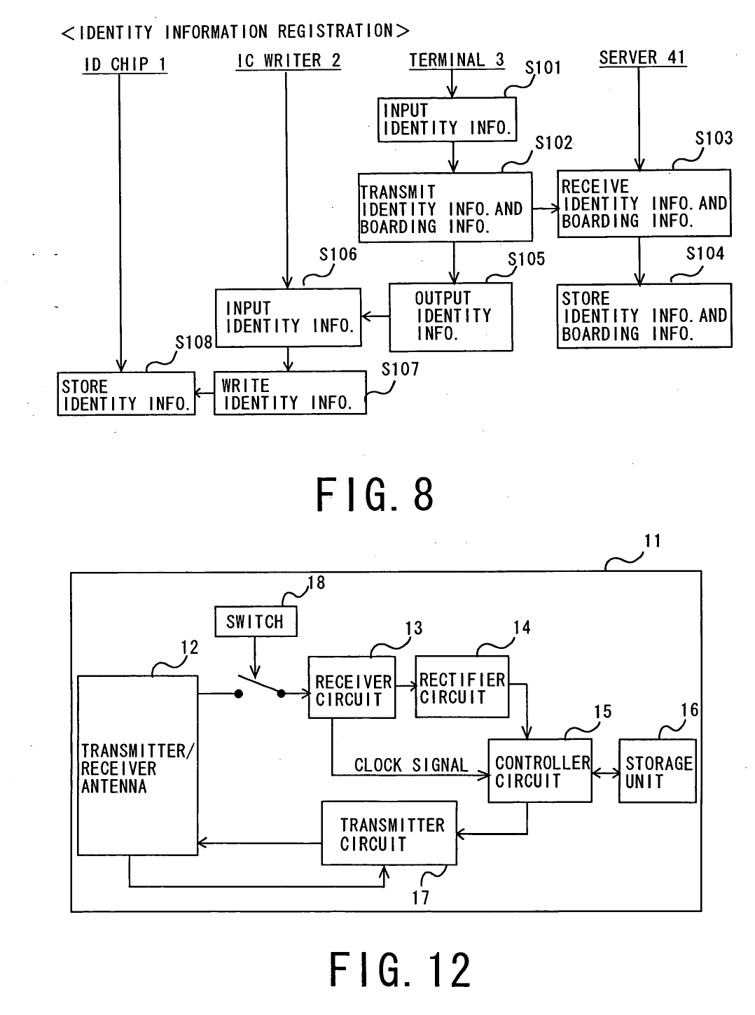

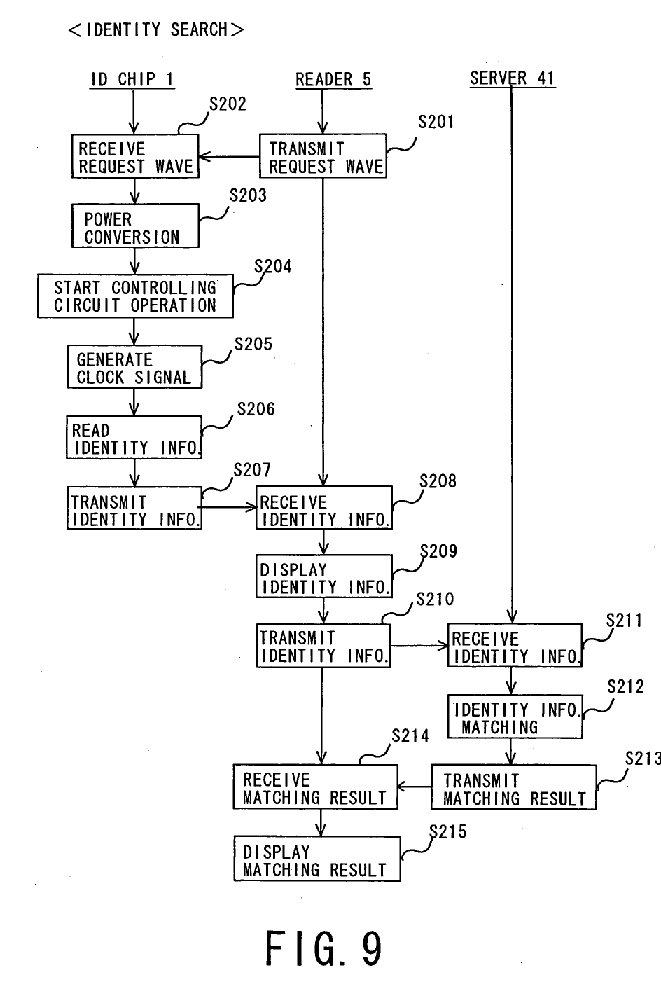

Now, the processing of the identification system according to the third embodiment of the present invention will be explained with reference to the flowcharts shown in FIGS. 8 and 9.

The flowchart in FIG. 8 shows the process of registering identity information on check-in procedures or airline ticket purchasing. First, an airline operator inputs identity information by an input unit of the terminal 3 (S101). For example, if the identity information is a passenger name, it is input based on the name information obtained at the time of reservation. If the name has been already stored in the terminal 3, an external server, or the like, the identity information may be input by reading out the stored name information. Since, however, the identity information is critical to identification, it may be preferred to ask passengers for some identification and input or confirm the identity information based on the identification.

After inputting the identity information, the operator operates the input unit of the terminal 3 to transmit the identity information and boarding information in association with each other to the server 41 (S102). The boarding information is the information managed by a normal reservation system, including a flight-number, a departure date, a departure airport, an arrival airport, a departure time, and a scheduled arrival time. All of the above information, however, is not necessarily included; single information specifying the flight to board may be sufficient.

The identity information and the boarding information is transmitted through the communication network 7 and received by the airline server 41 (S103). In the server 41, the identity information register section 413 stores the identity information and the boarding information in association with each other in the identity information storage section 422 of the database 42 (S104). The registration of the identity information in the airline database 42 is thereby completed.

The terminal 3 further transmits the identity information to the IC writer 2 (S105). The IC writer 2 receives the identity information (S106) and writes the identity information to the ID chip 1 (S107). The ID chip 1 stores the identity information in the storage unit 16 (S108). The registration of the identity information in the ID chip 1 is thereby completed.

The flowchart in FIG. 9 shows the process of searching for identity after an aircraft accident. First, the reader 5 is turned on and the transmitter circuit 57 of the reader 5 outputs a carrier wave to the transmitter/receiver antenna 59 for ID chip. The transmitter/receiver antenna 59 for ID chip sends it out as a request wave with a frequency of f1 (S201).

The ID chip 1 receives the request wave by the transmitter/receiver antenna 12 and the receiver circuit 13 (S202). Then, the rectifier circuit 14 converts the request wave received by the transmitter/receiver antenna 12 and the receiver circuit 13 into electric power (S203). The electric power is supplied to the controller circuit 15, which thereby starts operating (S204). In the meanwhile, the receiver circuit 13 generates a clock signal CLK from the request wave received by the transmitter/receiver antenna 12 (S205).

Upon receiving the clock signal CLK from the receiver circuit 13, the controller circuit 15 reads identification information from the storage unit 16 (S206). Then, the transmitter circuit 17 converts the request wave received by the transmitter/receiver antenna 12 into a carrier wave, multiplexes it with the identification information, and transmits it to the transmitter/receiver antenna 12. As a result of FSK modulation of the carrier wave with the identification information in the transmitter circuit 17, the frequency becomes f1±f2. Thus, a response wave having a frequency of f1±f2 is sent out from the transmitter/receiver antenna 12 (S207). Then, the receiver circuit 58 of the reader 5 extracts the identification information from the response wave received by the transmitter/receiver antenna 59 for ID chip (S208). The identity information from the ID chip 1 is thereby read.

The reader 5 displays the identity information by the display section 54 (S209). Further, the reader 5 transmits the identity information to the server 41 through the base station 6 and the communication network 7 (S210).

The server 41 receives the identity information (S211), and performs a process of matching the identity information by the emergency operation processing section 411 (S212). Specifically, it searches the identity information stored in the identity information storage section 422 of the database 42 to determine if the identity information from the reader 5 is included in the stored identity information. If the identity information is matched, the information indicating this result is added to the identity information storage section 422. The server 41 then transmits the matching result to the reader 5 by the emergency operation processing section 414 (S213).

The reader 5 receives the matching result (S214) and displays it by the display section 54 (S215).

As described in the foregoing, the identification system according to the third embodiment of the present invention enables easy identification with the use of the reader 5.

This embodiment explains a case that the process for matching the identity information is performed in the server 41. The identity information matching process, however, may be performed within the reader 5 by pre-downloading the registered identity information to the reader 5.

Embodiment 4

An identification system according to the fourth embodiment of the present invention has the same system configuration as but a different process flow from the identification system according to the third embodiment.

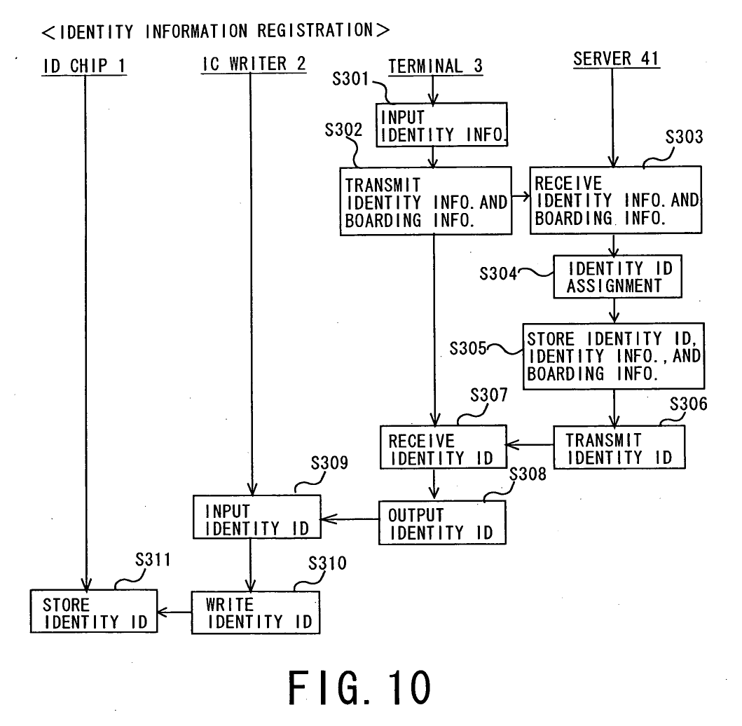

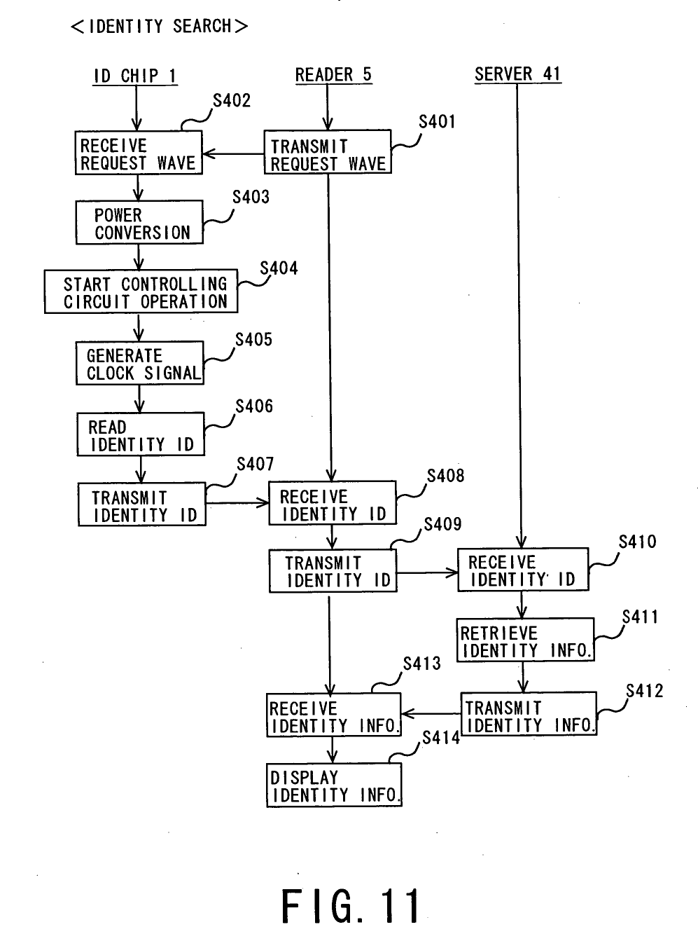

The processing of the identification system according to the fourth embodiment of this invention will be explained hereinafter with reference to the flowcharts shown in FIGS. 10 and 11.

The flowchart in FIG. 10 shows the process of registering identity information on check-in procedures or airline ticket purchasing. First, an airline operator inputs identity information by an input unit of the terminal 3 (S301). After inputting the identity information, the operator operates the input unit of the terminal 3 to transmit the identity information and boarding information in association with each other to the server 41 (S302).

The identity information and the boarding information is transmitted through the communication network 7 and received by the airline server 41 (S303). The server 41 assigns an identity ID based on the identity information and the boarding information (S304). The identity ID is unique identification information to each passenger. The same identity ID should not be assigned to more than one person in the same flight. The identity ID may be the same as that assigned in another flight. In the server 41, the identity information register section 413 stores the identity ID, the identity information, and the boarding information in association with each other in the identity information storage section 422 of the database 42 (S305). The registration of the identity information in the airline database 42 is thereby completed.

Further, the server 41 transmits the identity ID to the terminal 3 through the communication network 7 (S306). The terminal 3 receives the identity ID (S307) and outputs it to the ID writer 2 (S308).

The IC writer 2 receives the identity information (S309) and writes the identity information to the ID chip 1 (S310). The ID chip 1 stores the identity information in the storage unit 16 (S311). The registration of the identity information in the ID chip 1 is thereby completed.

The flowchart in FIG. 11 shows the process of searching for identity after an aircraft accident. First, the reader 5 is turned on and the transmitter circuit 57 of the reader 5 outputs a carrier wave to the transmitter/receiver antenna 59 for ID chip. The transmitter/receiver antenna 59 for ID chip sends it out as a request wave with a frequency of f1 (S401).

The ID chip 1 receives the request wave by the transmitter/receiver antenna 12 and the receiver circuit 13 (S402). Then, the rectifier circuit 14 converts the request wave received by the transmitter/receiver antenna 12 and the receiver circuit 13 into electric power (S403). The electric power is supplied to the controller circuit 15, which thereby starts operating (S404). In the meanwhile, the receiver circuit 13 generates a clock signal CLK from the request wave received by the transmitter/receiver antenna 12 (S405).

Upon receiving the clock signal CLK from the receiver circuit 13, the controller circuit 15 reads identity ID from the storage unit 16 (S406). Then, the transmitter circuit 17 converts the request wave received by the transmitter/receiver antenna 12 into a carrier wave, multiplexes it with the identity ID, and transmits it to the transmitter/receiver antenna 12. As a result of FSK modulation of the carrier wave with the identity ID in the transmitter circuit 17, the frequency becomes f1±f2. Thus, a response wave having a frequency of f1±f2 is sent out from the transmitter/receiver antenna 12 (S407). Then, the receiver circuit 58 of the reader 5 extracts the identity ID from the response wave received by the transmitter/receiver antenna 59 for ID chip (S408). The identity ID from the ID chip 1 is thereby read.

The reader 5 transmits the identity ID to the server 41 through the base station 6 and the communication network 7 (S409).

The server 41 receives the identity ID (S410) and performs a process of retrieving the identity ID by the emergency operation processing section 411 (S411). Specifically, it searches the identity ID stored in the identity information storage section 422 of the database 42 to acquire the identity information associated with the identity ID. Further, the information indicating that the retrieval process has been performed by the reader 5 is added to the identity information storage section 422. The server 41 then transmits the identity information to the reader 5 by the emergency operation processing section 414 (S412).

The reader 5 receives the identity information (S413) and displays it by the display section 54 (S414).

As described in the foregoing, the identification system according to the third embodiment of the present invention enables easy identification with the use of the reader 5.

This embodiment explains a case that the process for matching the identity information is performed in the server 41. The identity information matching process, however, may be performed within the reader 5 by pre-downloading the registered identity information to the reader 5.

Embodiment 5

The fifth embodiment of the present invention is characterized in that the ID chip 1 has a switch 18 as shown in FIG. 12. The switch 18 is designed so that a passenger can operate it from outside, and it may have various configurations. In one configuration, for example, the switch 18 may turn on when a passenger puts the ID chip 1 in the mouth and bites it. In another configuration, the switch 18 may have a humidity sensor and it may turn on when humidity reaches a certain level.

Providing the switch 18 allows information to be transmitted only from the ID chip 1 which has been actually used, thereby avoiding information interference.

Other Embodiments

Although the above embodiments explain the identification process in the context of boarding an aircraft, it is not limited thereto, and the process may be used in other situations, including when boarding a ship, train, and ropeway. Further, it is also possible that those who perform dangerous duties such as rescue team members or soldiers always have the ID chip for use at the time of danger.

Though the above embodiments explain a case where the identification information is electronically stored in memory of the ID chip, it may be mechanically or optically stored therein. For example, information such as a name may be engraved on a ceramic chip by laser.

It is preferred that the ID chip has a recording feature. This allows passengers to leave last words or emergency information in the event of an emergency. The recording feature may be composed of a voice input unit such as a microphone, a voice processing circuit, voice data memory, and so on. Though a longer recording time is preferred, it may be 10 to 30 seconds due to space and cost restrictions.

Further, though the ID chip transmits given identification information such as identity information and identity ID in the above embodiments, it may outputs a common recognition signal. This helps searching for a body.

The information to be stored in the ID chip may include, besides the identification information, information helpful in emergency medical care such as a blood type and past illnesses. This enables appropriate medical care for survivors.

Though, in the above embodiments, the ID chip is fed by a radio wave from outside, it is also possible to encapsulate the ID chip and a battery together and feed the ID chip from the battery. Applying this to the fifth embodiment allows preventing battery drain at normal times and also eliminating the need for a request unit when searching since the ID chip itself emits a radio wave; thus, only a receiver unit is required for searching.

### INDUSTRIAL APPLICABILITY

As described in the foregoing, the identification process according to the present invention is useful in identifying a victim in case of an aircraft accident, for example. Further, the present invention can provide a system and a device for identification.

1. An identification process of performing identification with a swallowable identification chip, comprising:
a step of inputting identification information for identifying an individual to be identified to the identification chip; and
a step of providing the identification chip where the identification information is input to the individual to be identified.

2. An identification process according to claim 1, further comprising a step that an individual to be identified swallows the identification chip.

3. An identification process according to claim 1, wherein the identification chip is attached to a ticket in the step of providing the identification chip to an individual to be identified.

4. An identification process according to claim 1, wherein the identification chip includes a spherical semiconductor on which the identification information is stored.

5. An identification process according to claim 1, wherein the identification information is information indicating a biological profile of an individual to be identified.

6. An identification chip to be swallowed by an individual to be identified and used for identification, comprising:
a storage unit storing identification information of the individual to be identified;
an input unit for inputting the identification information to the storage unit; and
an output unit for outputting the identification information from the storage unit.

7. The identification chip according to claim 6, wherein the storage unit comprises a spherical semiconductor.

8. The identification chip according to claim 6, wherein the input unit and the output unit comprise an antenna, a transmitter circuit, and a receiver circuit, and wirelessly communicate with an external unit.

9. The identification chip according to claim 6, further comprising a power converter for receiving a radio wave from an external unit and converting the radio wave into electric power.

10. The identification chip according to claim 6, further comprising a non-toxic cover.

11. The identification chip according to claim 6, further comprising a switching unit for controlling on/off of an operation of an internal circuit.

12. An identification system for identification, comprising:
a swallowable identification chip for storing identification information; and
an input unit for inputting the identification information to the identification chip.

13. An identification system according to claim 12, further comprising:
a biological information obtaining unit for obtaining information indicating a biological profile of an individual to be identified; and
a unit for inputting biological information obtained by the biological information obtaining unit to the identification chip.

14. An identification system according to claim 12, further comprising:
a terminal connected to the input unit;
a server connected to the terminal through a communication network; and
a reader connected to the server through a communication network,
wherein the terminal comprises a unit for transmitting identification information input to the identification chip to the server through a communication network,
the server comprises a storage unit for receiving identification information from the terminal and storing the identification information, and
the reader comprises a unit for reading identification information from the identification chip and transmitting the identification information to the server.
